(19) United States
(12) Patent Application Publication
(10) Pub. No.: US 2011/0107042 A1
(43) Pub. Date: May 5, 2011

(54) FORMATTING DATA STORAGE ACCORDING TO DATA CLASSIFICATION

(76) Inventor: Andrew Herron, Redmond, WA (US)

(21) Appl. No.: 12/611,132

(22) Filed: Nov. 3, 2009

(51) Int. Cl. G06F 12/16; G06F 12/00; G06F 12/02

(52) U.S. Cl. 711/161; 711/170; 711/E12.001; 711/E12.002; 711/E12.103

(57) ABSTRACT

A set of data can be classified into a data level of multiple possible data levels. Additionally, an indicator of the data level for the set of data can be transmitted to a storage device. In response to receiving the indicator, a storage area in the device can be formatted to store data at a storage quality level. The set of data can be stored in the storage area at the storage quality level.

### BACKGROUND

There are a wide variety of different types of computer storage devices. As used herein, a “storage device” is a device used to store data in a computing system, and can include devices such as magnetic storage devices (e.g., hard disk drives), solid state storage devices (e.g., solid state drives, block addressable flash memory on a system bus, and word addressable solid state memory such as phase change memory), smart cards, floppy drives, optical drives, etc. A storage device may be a logical drive, which can be spread across multiple physical drives and/or take up only a portion of a physical drive.

Currently storage devices are mostly considered homogenous by host computer components, including file systems. Subject to a few exceptions (e.g., in some situations where two storage devices appear as one), storage areas are considered equal by host computer components outside the storage devices themselves. Some storage devices are actually an amalgamation of multiple types of storage, such as a hard disk with an embedded solid state cache. In such a hybrid device, the solid state cache can make up a very small portion of the total space, and a file system can determine which files to place in the cache.

### SUMMARY

Whatever the advantages of previous data storage tools and techniques, they have neither recognized the tools and techniques for formatting data storage according to data classification described and claimed herein, nor the advantages produced by such tools and techniques.

In one embodiment, the tools and techniques can include classifying a set of data into a data level of multiple possible data levels. As used herein, a data level is a class into which data sets can be classified based on one or more criteria that indicate an expected importance and/or frequency of use of the data in the sets. Thus, different data levels can represent different levels of expected importance and/or expected frequency of use of data. Examples of different criteria are discussed below, but the term data level is not limited to any particular criteria or combination of criteria. Additionally, an indicator of the data level for the set of data can be transmitted to a storage device. Data level indicator is used herein broadly to refer to information that indicates a data level. Indicators can take numerous different forms. For example, an indicator could be a number corresponding to a pre-defined data level, a number representing historical frequency with which a set of data has been accessed, a single bit representing a high or low data level, a number representing an importance level assigned by a user, etc. In response to receiving the indicator, a storage area in the device can be formatted to store data at a storage quality level. As used herein, a storage quality level represents quality of storage in terms of speed, reliability, and/or resiliency. Thus, one quality level of storage differs from another different level by having a different expected speed (such as, for example, by having a different historical average access speed for that type of storage), a different expected reliability (such as, for example, by having a different historical average failure rate for that type of storage), and/or a different expected resiliency. Formatting refers to formatting a storage area to store data at one of multiple different quality levels. For example, a solid state storage area may be programmed to store a set of data in a region formatted in a specified cell level configuration, such as a single level cell (SLC) configuration or any of multiple multi level cell (MLC) configurations (2 bit per cell MLC, 3 bit per cell MLC, etc.). The formatting may include reformatting from one cell level configuration to another. The set of data can be stored in the storage area at the storage quality level.

In another embodiment of the tools and techniques, a set of data can be classified into a data level of multiple possible data levels, such as by a processor outside a storage device. If the data level is one level, then an instruction to format a first storage area on the storage device according to a first storage quality level, and to store the set of data at the first quality level in the first storage area can be sent to the device. If the data level is another level, then an instruction to format a second storage area on the storage device according to a second quality level that is different from the first quality level, and to store the set of data at the first quality level in the first storage area can be sent to the device.

In yet another embodiment of the tools and techniques, a set of data can be classified into a data level of multiple possible data levels at a computing component outside a solid state storage device. If the data level is one level, the storage device can be programmed by the computing component to store the set of data at a first cell level configuration, such as by the computing component sending on or more instructions to the storage device. If the data level is another level, the storage device can be programmed by the computing component to store the set of data at another cell level configuration.

This Summary is provided to introduce a selection of concepts in a simplified form. The concepts are further described below in the Detailed Description. This Summary is not intended to identify key features or essential features of the claimed subject matter, nor is it intended to be used to limit the scope of the claimed subject matter. Similarly, the invention is not limited to implementations that address the particular techniques, tools, environments, disadvantages, or advantages discussed in the Background, the Detailed Description, or the attached drawings.

### BRIEF DESCRIPTION OF THE DRAWINGS

FIG. 1 is a block diagram of a suitable computing environment in which one or more of the described embodiments may be implemented.

FIG. 2 is a block diagram of a data classification and storage computing environment.

FIG. 3 is a schematic diagram of another data classification and storage computing environment.

FIG. 4 is a flow diagram of a data classification and storage technique.

FIG. 5 is a flow diagram of another data classification and storage technique.

FIG. 6 is flow diagram of yet another data classification and storage technique.

### DETAILED DESCRIPTION

Embodiments described herein are directed to techniques and tools for improved formatting of data storage according to data classification. Such improvements may result from the use of various techniques and tools separately or in combination.

Such techniques and tools may include classifying data at different data levels that correspond to different storage quality levels, and then storing the data in different ways for the different quality levels. The classification can be done outside the storage device, such as by a computing component outside the device (e.g., an operating system or storage stack component) being executed by one or more processors outside the device. Data can be classified into a data level and a device can be programmed to store the data at a storage quality level corresponding to the data level. For example, an indicator of the data level can be transmitted to a storage device. In response, the storage device can format a storage area in the device to store data at a storage quality level corresponding to the data level, and the set of data can be stored in the area. For example, the storage quality level could be a cell level configuration (SLC, two bit per cell MLC, etc.).

Accordingly, one or more substantial benefits can be realized from the data classification and storage tools and techniques described herein. For example, data may be stored in ways that are appropriate for that class of data. For example, frequently accessed data may be stored at a storage quality level with fast retrieval times, important data may be stored at a storage quality level that has a high reliability, etc. Additionally, data that is not frequently accessed and/or unimportant may be stored at a storage quality level that is more efficient in terms of storage space but is slower or less reliable, thereby freeing up faster and/or more reliable storage for other data.

The subject matter defined in the appended claims is not necessarily limited to the benefits described herein. A particular implementation of the invention may provide all, some, or none of the benefits described herein. Although operations for the various techniques are described herein in a particular, sequential order for the sake of presentation, it should be understood that this manner of description encompasses rearrangements in the order of operations, unless a particular ordering is required. For example, operations described sequentially may in some cases be rearranged or performed concurrently. Techniques described herein with reference to flowcharts may be used with one or more of the systems described herein and/or with one or more other systems. Moreover, for the sake of simplicity, flowcharts may not show the various ways in which particular techniques can be used in conjunction with other techniques.

### I. Exemplary Computing Environment

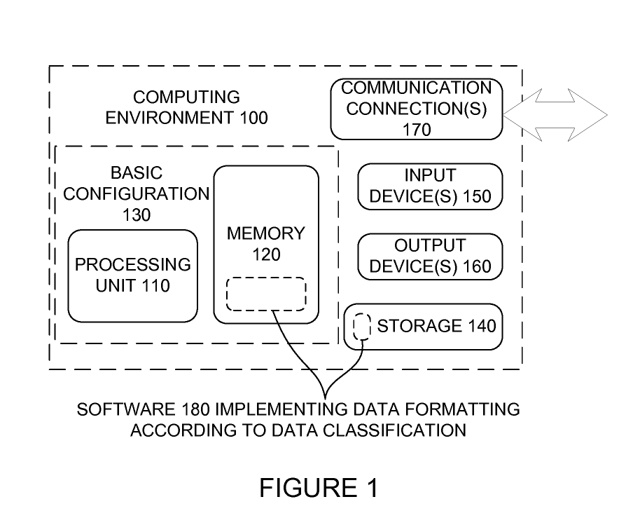

FIG. 1 illustrates a generalized example of a suitable computing environment (100) in which one or more of the described embodiments may be implemented. Generally, various different general purpose or special purpose computing system configurations can be used. Examples of well-known computing system configurations that may be suitable for use with the tools and techniques described herein include, but are not limited to, server farms and server clusters, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

The computing environment (100) is not intended to suggest any limitation as to scope of use or functionality of the invention, as the present invention may be implemented in diverse general-purpose or special-purpose computing environments.

With reference to FIG. 1, the computing environment (100) includes at least one processing unit (110) and memory (120). In FIG. 1, this most basic configuration (130) is included within a dashed line. The processing unit (110) executes computer-executable instructions and may be a real or a virtual processor. In a multi-processing system, multiple processing units execute computer-executable instructions to increase processing power. The memory (120) may be volatile memory (e.g., registers, cache, RAM), non-volatile memory (e.g., ROM, EEPROM, flash memory), or some combination of the two. The memory (120) stores software (180) implementing formatting of data storage according to data classification.

Although the various blocks of FIG. 1 are shown with lines for the sake of clarity, in reality, delineating various components is not so clear and, metaphorically, the lines of FIG. 1 and the other figures discussed below would more accurately be grey and fuzzy. For example, one may consider a presentation component such as a display device to be an I/O component. Also, processors have memory. The inventors hereof recognize that such is the nature of the art and reiterate that the diagram of FIG. 1 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 1 and reference to “computer,” “computing environment,” or “computing device.”

A computing environment (100) may have additional features. In FIG. 1, the computing environment (100) includes storage (140), one or more input devices (150), one or more output devices (160), and one or more communication connections (170). An interconnection mechanism (not shown) such as a bus, controller, or network interconnects the components of the computing environment (100). Typically, operating system software (not shown) provides an operating environment for other software executing in the computing environment (100), and coordinates activities of the components of the computing environment (100).

The storage (140) may be removable or non-removable, and may include computer-readable storage media such as magnetic disks, magnetic tapes or cassettes, CD-ROMs, CD-RWs, DVDs, or any other medium which can be used to store information and which can be accessed within the computing environment (100). The storage (140) stores instructions for the software (180). The storage (140) can include one or more storage devices, which can each include at least one storage device processing unit and storage device memory. The processing unit can execute computer-executable instructions (e.g., firmware stored in the storage device memory), typically to perform storage-related operations.

The input device(s) (150) may be a touch input device such as a keyboard, mouse, pen, or trackball; a voice input device; a scanning device; a network adapter; a CD/DVD reader; or another device that provides input to the computing environment (100). The output device(s) (160) may be a display, printer, speaker, CD/DVD-writer, network adapter, or another device that provides output from the computing environment (100).

The communication connection(s) (170) enable communication over a communication medium to another computing entity. Thus, the computing environment (100) may operate in a networked environment using logical connections to one or more remote computing devices, such as a personal computer, a server, a router, a network PC, a peer device or another common network node. The communication medium conveys information such as data or computer-executable instructions or requests in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The tools and techniques can be described in the general context of computer-readable media. Computer-readable media are any available media that can be accessed within a computing environment. By way of example, and not limitation, with the computing environment (100), computer-readable media include memory (120), storage (140), and combinations of the above.

The tools and techniques can be described in the general context of computer-executable instructions, such as those included in program modules, being executed in a computing environment on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing environment. In a distributed computing environment, program modules may be located in both local and remote computer storage media.

For the sake of presentation, the detailed description uses terms like “determine,” “choose,” “adjust,” and “operate” to describe computer operations in a computing environment. These and other similar terms are high-level abstractions for operations performed by a computer, and should not be confused with acts performed by a human being, unless performance of an act by a human being (such as a “user”) is explicitly noted. The actual computer operations corresponding to these terms vary depending on the implementation.

### II. Data Classification and Storage Systems and Environments

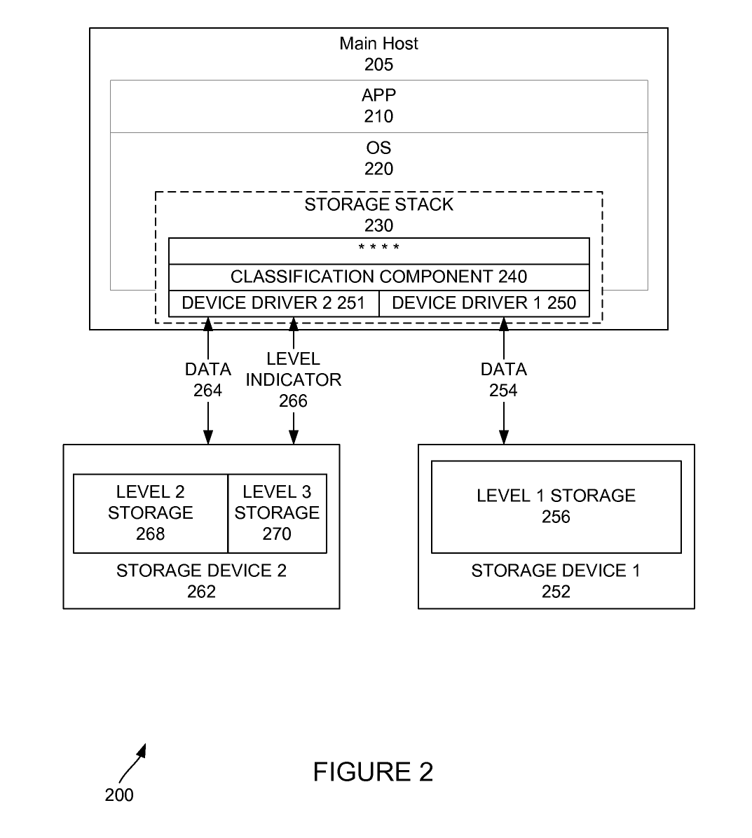

FIG. 2 is a block diagram of a data classification and storage computing environment (200). The computing environment (200) can include computing components similar to those described above with reference to FIG. 1. The computing environment (200) can include a main host (205), which can include hardware and/or software components hosting one or more applications (210) running on an operating system (220). For example, the main host (205) may be a physical or virtual machine. A storage stack (230) for passing data to be stored to one or more storage devices can include one or more operating system components and one or more components outside the operating system (220). For example, the storage stack (230) can include various standard filters, device drivers, etc.

The storage stack (230) can include a classification component (240). For data that is being passed down the storage stack (230) to be stored, the classification component (240) can be executed to classify the data into appropriate data levels that correspond to data storage quality levels. The classification component (240) can also program storage devices to store data at the corresponding storage quality levels, such as by passing information about the classification of the data farther down the storage stack. The classification component may also route data to appropriate storage devices. The classification component (240) may be located just above one or more device drivers (250 and 251) in the stack. Alternatively, the classification component (240) may be located in one or more other locations outside the storage devices in the system, such as farther up the storage stack, elsewhere inside or outside the operating system (220), or even as a separate device between the main host (205) and one or more storage devices.

In one example illustrated in FIG. 2, a first device driver (250) can interact with a first storage device (252) that can store data (254) in a first storage region (256) at a first storage quality level. As an example, the first storage device (252) can be a hard disk drive, and the first storage region (256) can be magnetic storage in the drive. In the example illustrated in FIG. 2, a second device driver (251) can interact with a second storage device (262). For example, the second storage device (262) can be a solid state storage device that can store data in a second storage region (268) at a second storage quality level, and a third storage region (270) at a third quality level. For example, the second storage region (268) can be programmed to store data according to a MLC format, and the third storage region (270) can be programmed to store data according to a SLC format. In this arrangement, operations in the third storage region would typically be faster than operations in the second storage region, and operations in the second storage region would typically be faster than the operations in the first storage region, at least for some operations such as random read or write operations.

An example of operation of the environment (200) will now be described. The classification component can classify sets of data into three data levels corresponding to the three storage regions (256, 268, and 270). For example, each set of data that is classified could be a file or even a portion of a file (e.g., a logical block or a set of logical blocks). Various different classification schemes can be used to determine appropriate data levels (and therefore appropriate data quality storage levels) for sets of data. For example, the classification component (240) can track the frequency with which sets of data are accessed. Data that is expected to be accessed more frequently could be classified into levels that correspond to storage quality levels with faster access times. As an example, the frequency of access could be tracked with counters in file metadata, with tables, or in some other manner. The past access frequency could be used to indicate the frequency with which sets of data are expected to be accessed in the future.

Additionally, the classification scheme could consider other factors, such as whether the file was authored by a particular user or on a particular machine, and/or whether the file was a particular file type. Authorship may be determined by examining metadata for a file. For example, some file types may be more likely to be important and/or more likely to be frequently accessed. Accordingly, some file types may always be at a higher data level (corresponding to a higher data storage quality level), some file types may always be at a lower data level (corresponding to a lower data storage quality level), and other file types may be assigned to a data level based on the frequency with which they have been used.

As another example, user input, an application (210), and/or an operating system (220) could identify data levels to which particular files or portions of files are classified. However, it may be useful to limit the effect of such classifications by particular applications because such applications may be programmed to promote their own performance at the expense of other applications. For example, an application may be allowed to identify the relative importance or expected frequency of use for different sets of data that are used by that application. As one specific example, an email program may request that emails received in the past two days be assigned to higher data levels than older emails because the newer emails are more likely to be important and more likely to be accessed frequently. Such identification by an application may be particularly useful for applications that handle large amounts of data, such as email routing servers and database servers.

As yet another example of a factor that can be used in classification, data that has been backed up could be more likely to be classified to a higher data level because backing up sets of data could indicate that those data sets are important.

Referring still to FIG. 2, in response to some triggering event, the classification component can classify a set of data to a data level. For example, a triggering event may be a read, write, or modification of the data set. As another example, the triggering event may be a timer that triggers classification of certain data sets. If the classification component (240) classifies the set of data to a first data level corresponding to the first storage region (256), then the classification component (240) can send an instruction for the data to be stored in the first storage region (256), such as by passing the data to the first device driver (250), which can instruct the first storage device (252) to store the data by sending the data (254) to the first storage device (252).

If the classification component (240) classifies a data set to second or third data levels corresponding to the second storage region (268) and the third storage region (270), respectively, then the classification component (240) can program the second storage device (262) to store each set of classified data (264) in the appropriate storage region (268 or 270). For example, the classification component (240) can pass data (264) to the second device driver (251) along with a level indicator (266), thereby instructing the second device driver (251) to have the data stored in the data storage region (268 or 270) corresponding to the indicated level in the second storage device (262). The second device driver (251) can pass the data (264) and the level indicator (266) on to the second storage device (262).

The level indicator (266) may indicate a level and indicate a data set to which the level applies. For example, the level indicator (266) may identify a level (such as by including a level number), and may also identify a group of one or more data blocks, such as by listing one or more logical block addresses (LBA's). For one or more contiguous logical block addresses, the level indicator (266) may indicate a logical block address range, or ranges, to which it applies.

Upon receiving a level indicator (266), the second storage device (262) can store the indicated data set in the indicated storage region (268 or 270). The storage regions (268 and 270) may or may not be located in separate continuous physical areas of the second storage device (262). Indeed, the regions (268 and 270) but may be interspersed in a way that can be determined by the second storage device (262). Storing the data set can include formatting an area of the appropriate storage region (268 or 270) for storage of the indicated data set. This may include re-formatting an area of one region (268 or 270) so that it becomes part of another region (268 or 270).

For example, if the third storage region (270) is full and a level indicator (266) indicates that another data set (264) is to be stored in the third storage region, then the second storage device (262) can reformat an area of the second storage region (268) to have the characteristics of the third storage region (270), so that the area becomes part of the third storage region (270). For example, if the second storage region (268) is MLC solid state storage and the third storage region (270) is SLC solid state storage, then some MLC storage can be reformatted to be SLC storage. Of course, this reformatting can decrease the amount of data that can be stored in the second storage device (262), but it can improve performance when accessing the new data to be stored in the third storage region (270).

As another example, if some data stored in the third storage region (270) is not used for a long period of time, it may be re-classified to the second data level corresponding to the second storage region (268). In that situation, the classification component (240) can pass a level indicator (266) to the second device driver (251), indicating one or more logical block addresses and the data level to which they are now classified (the second data level). In response, the second storage device (262) can reformat some SLC storage to be MLC storage, and can store the indicated data set in the MLC storage. This change may decrease performance when accessing the indicated data set (because accessing MLC storage is typically slower than accessing SLC storage), but the change may free up additional storage space on the second storage device (262) (because MLC is compressed as compared to SLC).

While this specific example of a data classification and storage environment has been described, many variations and alternative data classification and storage environments can be implemented. For example, the first storage device (252) and the first device driver (250) could be omitted, or the classification component (240) could be configured to send classified data only to the second storage device (262). As another example, additional storage devices and/or storage regions could be included, such as by including storage regions in the second device (262) that are respectively formatted for SLC, two bit per cell MLC, three bit per cell MLC, etc.

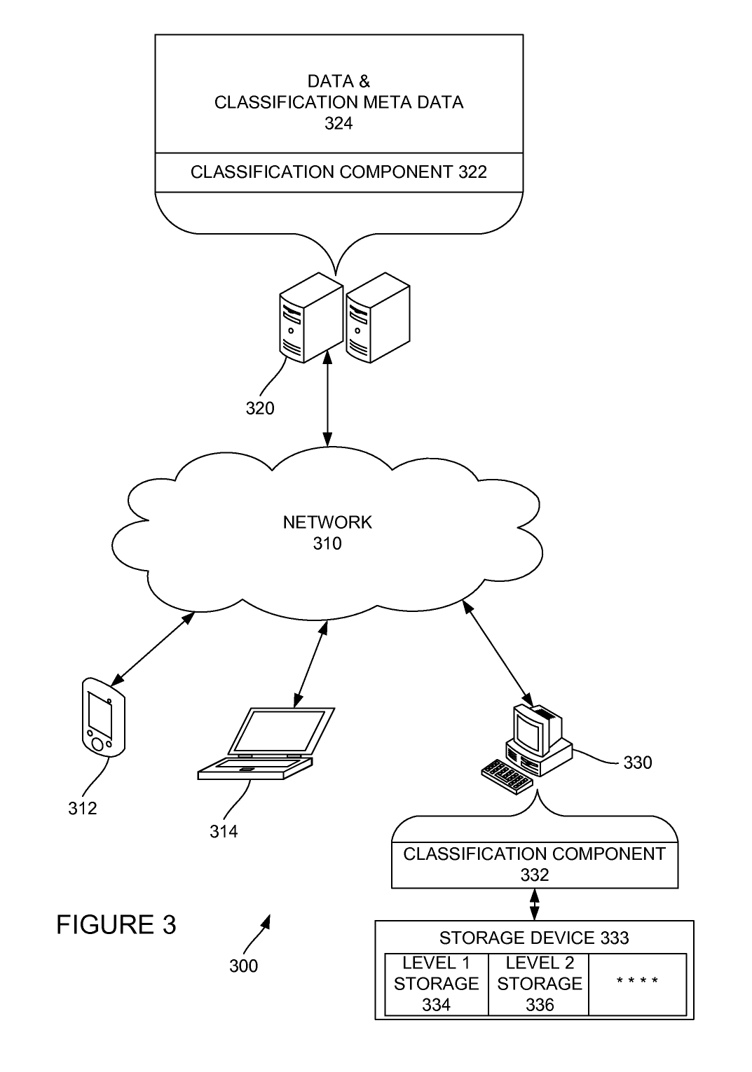

As yet another example of a variation, referring now to FIG. 3, a data classification and storage environment (300) that involves a network (310) will be described. Multiple devices such as user machines (312 and 314) can access the network (310), such as by sending and receiving data that is transmitted across the network. A data site (320) can also access the network (310). The data site can include a classification component (322) that can classify data according to a scheme, such as the types of schemes discussed above with reference to FIG. 2. In addition, the data site can include a data store (324) that can store classification metadata, as well as data itself. The classification metadata may include information to be used in classification and/or the results of such classification. For example, the classification metadata can include indicators of the frequency with which a particular file in the data store (324) is accessed by others across the network. The classification metadata may also include information on the frequency with which sets of data in the data store are accessed by particular users or groups of users, or by particular machines or groups of machines. The classification metadata can be tracked in the same manner that such information is currently tracked by using user logins, cookies, network addresses, etc. to identify particular users/machines or groups of users/machines.

In addition to or instead of such tracking, the classification component (322) can track other information that is not particular to data sets stored at the data site (320). For example, users may opt into providing statistical information to the data site (320) over the network, and that statistical information could be used in classification. For example, the statistical information could indicate how frequently particular file types are accessed or backed up, what applications utilize those file types, etc. Such statistical information could be used to classify sets of data, at least initially.

Another machine (330) may be configured to access the network (310) to receive classification data from the data site (320). Such classification data may include particular assignments of particular data sets to particular data levels, statistical usage information, assignments of file types to default initial data levels (which may change with actual usage of the files on the machine (330)), etc. The machine (330) can include a classification component (332), which can use the classification information from the data site (320) to program a storage device (333) to store particular data sets to particular storage regions (334 or 336) having particular storage quality levels (e.g., SLC formatted regions, one bit per cell MLC formatted regions, etc.), as discussed above with reference to the second storage device (262) in FIG. 2. Thus, the classification component (332) at the machine (330) and the classification component (322) at the data site (320) may both be part of the classification computing component that classifies data and programs a storage device store the data according to the classification. The classification of particular data sets to particular data levels that correspond to data storage quality levels can be done by the classification component (332) on the machine (330), by the classification component (322) on the data site (320), or some combination thereof. As an example, the classification component (332) may be a storage stack component, as discussed above with reference to FIG. 2.

### III. Data Classification and Storage Techniques

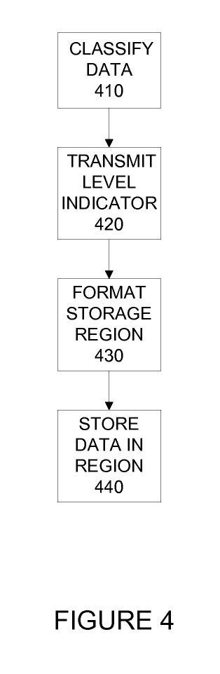

Referring to FIG. 4, a data classification and storage technique will be discussed. This technique and the others below may be implemented in a computing environment such as those discussed above or some other computing environment. The technique can include classifying (410) a set of data into a data level of multiple possible data levels. This can include determining how frequently data is expected to be accessed. This determination may or may not yield an exact expected frequency. For example, the expected frequency may be expressed in various different ways, such as a relative amount (e.g., indicating that one file type is expected to be accessed more frequently than another file type), as an assignment to a data level, as an estimate such as one based on past frequency statistics, etc. Classifying may include determining an expected importance. Again, this determination need not be exact, and could take the form of estimates, judgments indicated by a user, judgments indicated by an application or operating system developer, determinations based on past user behavior (determining data is important if a user backs it up frequently, etc.). Classifying can include analyzing behavior across multiple computing machines, such as by analyzing data transmitted across a network. For example, this can include analyzing data transmitted across a local network or across a global network, such as the Internet. Additionally, classifying can include analyzing behavior of a single user or of multiple users.

An indicator of the data level for the set of data can be transmitted (420) to a storage device. In response to receiving that indicator, a storage area in the device can be formatted (430) to store data at a storage quality level, which can correspond to the data storage level. This formatting can include reformatting the storage area from a first quality level to a second quality level. The two quality levels can have different characteristics. For example, the second quality level can have different expected access speeds than the first quality level. As another example, the second quality level can have different expected reliability than the first quality level. As one specific example, formatting the storage area can include switching the storage area between SLC and MLC configurations. Formatting the storage area may change a ratio between amounts of different storage quality levels in the storage device. For example, the formatting may change a storage area between different cell level configurations (e.g., between MLC and SLC storage or between different levels of MLC storage), so that a ratio of bytes of one cell level configuration in the device to another cell level configuration in the device changes. Additionally, the formatting may change how much data storage space is available in the device. For example, switching a storage area from SLC storage to MLC storage can increase the data storage space available in a solid state storage device.

Moreover, the set of data can be stored (440) in the storage region at the storage quality level, such as in MLC storage, SLC storage, or some other storage configuration.

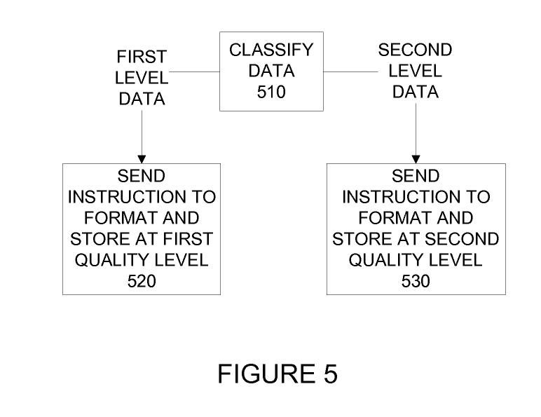

Referring now to FIG. 5, another data classification and storage technique will be discussed. The technique may generally be performed in a computer system by one or more processors outside a storage device executing instructions in a memory. Additionally, some acts performed by the storage device may be performed by one or more processors in the storage device executing instructions in a storage device memory. Alternatively, the technique may be performed in some other environment. In the technique, a set of data can be classified (510) into a data level of multiple possible data levels. If the data level is a first level, then the technique can include sending (520) an instruction to format a first storage area on the storage device according to a first storage quality level, and to store the set of data at the first quality level in the first storage area. If the data level is a second level, then the technique can include sending (530) an instruction to format a second storage area (which may be the same physical area as the first storage area, or a different physical area) on the storage device according to a second quality level that is different from the first quality level, and to store the set of data at the first quality level in the first storage area. The technique can also include sending an instruction to a second storage device to store the set of data if the data level is a third level. For example, the first storage device may be a solid state storage device, and the second storage device may be a magnetic storage device. Classifying can include determining an expected frequency of access and/or an expected importance of the data. In addition, where the storage device is a solid state storage device, the first quality level can be a first cell level configuration, and the second quality level can be a second cell level configuration.

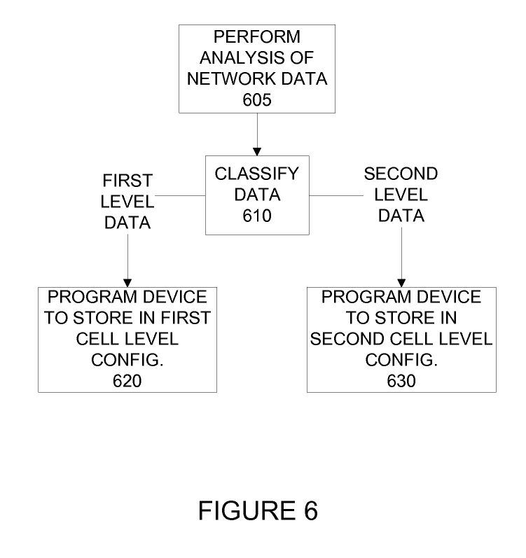

Referring now to FIG. 6, yet another technique for classification and storage of data will be described. Data transmitted across a network can be analyzed (605), and the analysis can be used in classifying (610) the set of data into a data level of multiple possible data levels at a computing component outside a solid state storage device. For example, the network may be a local network, or a global network such as the Internet. Alternatively, classifying (610) can be done using some other information and/or analysis. If the data level is a first data level, then the technique can include the computing component programming (620) (which may be reprogramming if the data is already stored at a different cell level configuration) the storage device to store the set of data in a first cell level configuration. If the data level is a second data level, then the technique can include the computing component programming (630) (which may be reprogramming if the data is already stored at a different cell level configuration) the storage device to store the set of data in a second cell level configuration. For example, the second storage quality level can include MLC storage, and the first storage quality level can include SLC storage, or the two quality levels can each be a different level of MLC storage (2 bit versus 3 bit, etc.).

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

I/we claim:

1. One or more computer-readable storage media having computer-executable instructions embodied thereon that, when executed by at least one processor, cause the at least one processor to perform acts comprising:
classifying a set of data into a data level of multiple possible data levels;
transmitting to a storage device an indicator of the data level for the set of data;
in response to receiving the indicator, formatting a storage area in the device to store data at a storage quality level; and
storing the set of data in the storage area at the storage quality level.

2. The method of claim 1, wherein the storage quality level is a second storage quality level and wherein formatting the storage area comprises reformatting the storage area from a first quality level to the second quality level.

3. The one or more computer-readable storage media of claim 2, wherein the second quality level has different expected access speeds than the first quality level.

4. The one or more computer-readable storage media of claim 2, wherein the second quality level has a different expected reliability than the first quality level.

5. The one or more computer-readable storage media of claim 1, wherein the device is a solid state device, and wherein formatting the storage area comprises switching the storage area between different cell level configurations.

6. The one or more computer-readable storage media of claim 1, wherein formatting the storage area changes a ratio between amounts of different storage quality levels in the storage device.

7. The one or more computer-readable storage media of claim 1, wherein formatting the storage area changes how much data storage space is available in the device.

8. The one or more computer-readable storage media of claim 1, wherein classifying comprises determining how frequently the data is expected to be accessed.

9. The one or more computer-readable storage media of claim 1, wherein classifying comprises determining an expected importance of the data.

10. The one or more computer-readable storage media of claim 1, wherein classifying comprises analyzing behavior across multiple computing machines.

11. The one or more computer-readable storage media of claim 1, wherein:
the storage device is a solid state device;
the quality level is a cell level configuration; and
classifying comprises determining one or both of an expected importance of the set of data and a frequency with which the data is expected to be accessed.

12. A computer system comprising:
a storage device;
at least one processor outside the storage device; and
a memory storing instructions thereon that when executed by the at least one processor cause the at least one processor to perform acts comprising:
classifying a set of data into a data level of multiple possible data levels;
if the data level is a first level, then sending an instruction to the storage device to format a first storage area on the storage device according to a first storage quality level, and to store the set of data at the first quality level in the first storage area; and
if the data level is a second level, then sending an instruction to the storage device to format a second storage area on the storage device according to a second quality level that is different from the first quality level, and to store the set of data at the first quality level in the first storage area.

13. The computer system of claim 12, wherein the acts further comprise:
if the data level is a third level, then sending an instruction to a second storage device to store the data.

14. The computer system of claim 12, wherein classifying comprises determining a frequency with which the set of data is expected to be accessed.

15. The computer system of claim 12, wherein classifying comprises determining an expected importance of the data.

16. The computer system of claim 12, wherein the first quality level is a first cell level configuration, and wherein the second quality level is a second cell level configuration.

17. A computer-implemented method, comprising:
at a computing component outside a solid state storage device, classifying a set of data into a determined data level of multiple possible data levels;
if the determined data level is a first data level, then programming the storage device to store the set of data in a first cell level configuration, the programming to store in the first configuration being performed at least in part by the computing component; and
if the determined data level is a second data level, then programming the storage device to store the set of data in a second cell level configuration, the programming to store in the second configuration being performed at least in part by the computing component.

18. The method of claim 17, wherein the second cell level configuration is a multi level cell configuration and the first cell level configuration is a single level cell configuration.

19. The method of claim 17, wherein the method further comprises performing an analysis of data sent across a network, and wherein classifying the set of data uses the analysis.

20. The method of claim 17, wherein:
if the determined data level is the first data level and the set of data is already stored on the device at a configuration other than the first cell configuration, then programming the storage device to store the set of data in the first cell configuration comprises reprogramming the storage device to store the set of data at the first cell configuration; and
if the determined data level is the second data level and the set of data is already stored on the device at a configuration other than the second cell configuration, then programming the storage device to store the set of data in the second cell configuration comprises reprogramming the storage device to store the set of data at the second cell configuration.
